(19) United States
(12) Patent Application Publication
(10) Pub. No.: US 2018/0295784 A1
(43) Pub. Date: Oct. 18, 2018

(54) GELS AND DEVICES FOR PRESERVATION OF CUT FLOWERS

(71) Applicant: Sudhir Jaiswal, Fremont, CA (US)

(72) Inventor: Sudhir Jaiswal, Fremont, CA (US)

(21) Appl. No.: 15/855,867

(22) Filed: Dec. 27, 2017

Related U.S. Application Data
(60) Provisional application No. 62/439,794, filed on Dec. 28, 2016.

(51) Int. Cl. A01G 5/06

(52) U.S. Cl. CPC A01G 5/06

(57) ABSTRACT

This invention provides systems and methods of preserving cut plants. The system can include a container partly full of a gel media covered with a liquid media, meeting the initial high liquid demand of cut plants, while providing spill control for shipping and handling. The methods include preparation of the system container to receive cut plants through an upper liquid media layer into a lower gel layer.

### FIELD OF THE INVENTION

Methods and systems for preservation of cut plants. Systems provide for variable water demand of cut plants with a high flow liquid media to alleviate the high demand early hydration after cutting, and a hydrated gel media to provide for more long term water demand in a supportive and spill reducing structure. Cut plants are thrust through and captured by a container cap, through an upper liquid media, and into the media gel. The cut plants soon consume the liquid media, and are ready to be handled without spilling in transport and display.

### BACKGROUND OF THE INVENTION

The importance of preserving plants and cut flowers continues to increase as consumers demand a greater selection of plants and flowers from around the world. Consumers have come to expect florists to provide a variety of non-indigenous plants, and out of season flowers, from around the world. Better cut plant and flower preservation can allow longer enjoyment of flowers by customers after jet/ocean transport, regional wholesaling, and retail display.

One requirement for preservation of most cut plants is water. Many flowers and plant parts quickly lose turgidity and wilt without a ready supply of water at the cut stem. It is an ancient practice to increase the attractive life of the flowers by keeping cut stems in water, typically refilling and changing infested water as the flowers degrade. Provision of preservative media with certain salts and sugars in the water, to maintain an appropriate osmotic balance, has been known to forestall wilting of cut flowers. These approaches, though useful, provide only a short respite from wilting and degradation for many types of cut flowers. In addition, the presence of liquids in flower shipments has been forbidden by many airlines, due to the potential damage from spilled solutions on the aircraft and cargo.

Flower wilting can be caused by exposure to ethylene, a gaseous natural plant hormone that can be generated in the cut flowers. Ethylene levels can be reduced by supplying ventilation. For example, in U.S. Pat. No. 4,515,266 to Meyers, “Modified Atmosphere Package and Process”, produce is preserved by venting a storage container with a mixture of inert gasses. Another way to minimize the damage caused by ethylene is by application of anti-ethylene agents, such as, e.g., MCP (methylcyclopropene), which is known to inhibit ethylene production under certain conditions.

While liquid media can provide hydration to cut plants, the appearance and shelf-life of the plants can be diminished when the liquid spills into the environment or onto the plants themselves. In Castleberry (U.S. 2014/0096444) a sealed container is provided with a liquid media chamber separated from cut stem ends through a complex system of seals and capillary flow paths. However, the system is relatively expensive in materials and not compatible with efficient high throughput processing of cut flowers. Further, these systems generate high ambient humidity and condensation that can reduce the shelf life of the cut plant.

In view of the above, we have seen that a need exists for ways to initially handle and hydrate plants while also providing a spill proof media containment for shipping. It would be desirable to have a system that are simple and do not require cut plant wholesalers to make time-consuming manipulations (e.g., changing water, cleaning holding buckets) to provide timely and appropriate hydration of cut plants. The present invention provides these and other features that will be apparent upon review of the following.

### SUMMARY OF THE INVENTION

The present inventions include systems and methods for extending the attractive appearance and wholesomeness of cut plants. We have observed that cut plants often have a much higher water or liquid media demand in the first hours after they have been harvested. Later, the cut plants (typically flowers) are handled, transported and displayed in conditions where liquid media are likely to be spilled. The systems and methods described herein provide efficient solutions to these problems.

Systems for preserving cut plants can include fluid delivery systems allowing high consumption in a first phase, and a protective and spill-proof media delivery mechanism in a second phase. For example, a system for preserving cut plants can include a media container with a gel media at a bottom, and a liquid media layer above the gel media in the container. The media container can have a cap, e.g., with one or more projections extending axially inward to support and capture cut plants inserted into the container. In some embodiments, the container bottom is flexible enough to allow massaging or crushing the gel material to expedite release of liquid media at certain phases of processing or holding the plants.

In one aspect of the invention, the gel in the container is initially without a liquid layer above, but crushing the gel releases free liquid media on demand For example the container partly filled with gel can be flexible so that the gel can be disturbed mechanically when desired by the user. Mechanically disrupting the gel matrix can be by a user squeezing a flexible container (e.g., plastic bag) by hand. Liquid can be released from the fragmented or compressed gel. The liquid can be interspersed among gel fragments and/or in a layer above the gel. Cut plant ends in the disrupted gel can readily receive the liberated liquid media.

The gel media for the bottom of the container can be any appropriate for the particular plant to be preserved. Typically the gel is made up of a hydrated hydrophilic matrix or polymer. For example, preferred gel media can include a hydrophilic gel such as a polyacrylamide, an agarose, and/or the like. In the case of many hydrophilic gels, such as agarose, gel media contains from 1.5 g/L to 4 g/L total solids of the gel substrate material, typically in an aqueous environment. While the gel can be in the form of gel beads, or crushed gel matrix, the preferred form is as a continuous gel matrix. The gel media can be hydrated with any liquid media appropriate to the particular cut plant. However, the gel is often hydrated with the same liquid media as is used in an associated liquid media layer. The ratio of the bottom gel media to the top liquid media in the container can range from less than 0.5:1 to more than 20:1, from 1:1 to 10:1, or about 5 parts gel to 1 part liquid media.

The system can further include a plastic sleeve projecting up from the media container to protect the cut plants and help control the ambient environment above the container. The sleeve comprises a lower section near the media and container, and an upper section enclosing the upper parts of the plant(s). For example, the sleeve can have from 0 to more than 1000 perforations of 1 mm or more. In some embodiments, the sleeve can have from 4 to 16 perforations in a lower 20% of the sleeve above the container and from 100 to 400 perforations in the upper 80% of the sleeve above the container. The sleeve can be generally porous, e.g., with micro/nano-channels through a sleeve membrane matrix. More commonly, the sleeves have perforations ranging in diameter from less than 1 mm to more than 10 mm, from about 3 mm to 6 mm, or about 4 mm The sleeve plastic can have any suitable thickness, e.g., a thickness ranging from less than 0.5 mil to more than 3 mil, from 0.75 mil to 2 mil, or about 1.5 mil. The sleeve can be textured, e.g., to reduce adhesion of plant parts.

The systems can include cut plants. The cut plants can be cut on a surface and the cut surface placed inside the container with the cut surface in the gel media. For example, the cut surface can be a plant stem, such as a flower stem, cut fully across separating the root system. Typical plants in the preservative system can include, e.g., a cut flower, a daisy, a rose, an Asteraceae, a Compositae, a fruit, a vegetable, and or the like.

The inventions include methods of preserving cut plants. For example, a method of preserving a plant can include providing a media container with a closed bottom end, side walls, and a top end; placing a gel media in the bottom end of the container; placing a liquid media in the container so that it rests in a layer above the gel media; and, placing a cut surface of the plant into the gel media. Optionally, the liquid can be in a layer below the gel layer matrix.

The cut surface can be sanitized and pre-hydrated, e.g., by placing the cut surface of the plant in a sanitizing and hydrating solution, such as a mild bleach solution, before the cut surface is placed into the gel media.

The cut plant can be placed in the container and held until the liquid media layer above the gel media is consumed. The amount of liquid media provided on top of the gel media can be adjusted, for a particular plant and handling logistics, so that the liquid media is consumed, leaving only the gel when it is time to further handle or transport the cut plants. That is, e.g., the method can include transporting the cut plants in the container after the liquid media above the gel media is consumed. The cut plant can be held in the gel media until at least 50% of a hydrating liquid is consumed, e.g., before handling that could cause spillage. Water content of the media can be further reduced to allowing the gel to form a supportive, protective, and water retaining membrane skin as the hydrating liquid is consumed.

In one aspect, it can be beneficial to later provide additional liquid media, as required at certain times in the useful life of the cut plant. For example, the methods can include breaking the gel matrix of the gel media to release a liquid to the plant, or applying additional liquid media above the gel media after an initial liquid media has been consumed.

In another embodiment, the liquid media is not initially provided as a liquid layer above the gel in the container. In one aspect, the liquid media is made available to the cut plant surface by disrupting the gel to release the liquid media. For example, a system for preserving cut plants can include a flexible media container with a gel media at a bottom of the container. The gel can be adapted to release liquid media when compressed or crushed by external forces through the flexible container. Alternately, the container is not flexible, but the gel is disrupted by external forces, e.g., an abrupt impact. The liquid media released can provide, e.g., a liquid layer above the gel and/or a liquid component interspersed with crushed gel fragments. Many highly hydrated gels can function in this embodiment, e.g., a polyacrylamide gel or an agarose gel.

A method of providing liquid media on demand is an aspect of the present inventions. For example, a method of providing liquid media to a cut plant can include providing an aqueous gel in a flexible container, inserting a cut surface of a cut plant into the gel, and applying a force to the flexible container. The compressing or crushing of the gel caused by the external force releases liquid media from the gel making the liquid media available to the cut plant surface.

### DEFINITIONS

Before describing the present invention in detail, it is to be understood that this invention is not limited to particular device, methods, or biological systems, which can, of course, vary. It is also to be understood that the terminology used herein is for the purpose of describing particular embodiments, and is not intended to be limiting. As used in this specification, the singular forms “a”, “an” and “the” can include plural referents unless the content clearly dictates otherwise. Thus, for example, reference to “a surface” can included a combination of two or more surfaces; reference to “bacteria” can include mixtures of bacteria, and the like.

Unless defined otherwise, all technical and scientific terms used herein have the same meaning as commonly understood by one of ordinary skill in the art to which the invention pertains. Although any methods and materials similar or equivalent to those described herein can be practiced without undue experimentation based on the present disclosure, preferred materials and methods are described herein. In describing and claiming the present invention, the following terminology will be used in accordance with the definitions set out below.

The term “agar”, as used herein, refers, e.g., to any of a variety of aqueous polysaccharide extracts from agarophyte sea weeds, such as Gelidium, Gracilaria, Ceramium, Phyllophora, Pterocladia, Ahnfeltia, Campylaephora, Acanthopelitis, and the like. Agar of the invention can include, for example, agar, agarose, phytagar, agar-agar, agarobiose, and phycocolloid. Agar can be, e.g., any member of the family of 1, 3-linked galactopyranose and 3, 6-linked 3, 6-anhydro-L-galactopyranose polymers.

Gels are as known in the art. Gels can include three dimensional matrices or polymer suspensions thick enough so that the gel does not behave like a liquid. For example, gels are mostly liquid (as described herein) but have a three dimensional cross-linked or thickened network within the liquid. While a liquid can be readily poured from a container, a gel tilted 90 degrees will take, e.g., at least 5 times as long, 25 times as long, or 100 times as long to pour as water from the same container.

The term “anti-microbial” includes, e.g., antibiotics, anti-fungal agents, antiseptics, anti-microbial plant compositions and extracts that can kill or slow the growth of microbes. Bactericides are materials, other than antibiotics, that kill bacteria, on contact, such as antiseptics. Antibiotics are not considered antiseptics and include bactericidal or bacteriostatic antibiotics.

The term “plant” refers to, e.g., one or more whole plants, uprooted plants and/or cut plants, including cut flowers. Cut plants are typically flowers cut at the stem. However, the term can include other cut plants, such as fruits and vegetables. Plants of the invention may be cut and dying, but still contain viable cells, e.g., requiring hydration to stay alive.

The term “preservative media”, as used herein, refers to a solution and/or colloidal suspension of preservative constituents in water. Water itself can optionally be considered a preservative media.

The term “sealed”, as used herein with regard to compartment openings or boundaries between compartments, refers to creation of a seal at an opening between the compartments (or, e.g., at the blossom compartment top opening) so that migration of compartment contents past the seal is not substantial. For example, transport of gasses or liquids across a sealed opening is reduced at least 50%, at least 60%, at least 75%, at least 85%, at least 90%, at least 95%, at least 98%, at least 99%, or 100%, when the opening is sealed. Compartments can be considered sealed even though the compartment walls may have perforations that allow transport of gasses through the wall.

### BRIEF DESCRIPTION OF THE DRAWINGS

FIG. 1 is a schematic diagram of a preservation system for cut plants including cut flowers having cut stems in the gel of a media container, and surrounded by a sleeve.

FIG. 2 is a schematic diagram of an exemplary container cap with inner protrusions, e.g., to capture cut plants and enhance containment of media.

FIG. 3 is a schematic diagram of the preservation system without plants but showing other constituents including a region for holding a container and media, and sleeve perforations.

FIG. 4 is a diagram of a representative sleeve layout on a bilayer of sheet plastic.

FIG. 5 is an example of a cut plant preservation system including daisies in a liquid/gel layered media in a container, all retained in a perforated sleeve.

FIG. 6 is a schematic diagram showing a plant preservation array system.

### DETAILED DESCRIPTION

The present inventions include systems and methods for preserving cut plants in storage and transport. The systems include, e.g., a gel media in a container covered with a layer of liquid media. The methods can include insertion of plant cut ends into the gel, e.g., thereby conveniently providing a ready source of preservative media to the cut plant during initial processing, and a spill proof gel media for transport and retail presentation.

A number of methods and compositions are discussed in the Summary of the Invention and further details are provided herein and in the Examples section. As would be readily appreciated by the skilled person, the disclosures can be read in combination.

### Systems for Handling and Preserving Cut Plants

The systems are designed to provide simple and convenient handling of cut plants as they are processed, stored, and shipped. The basic system includes, e.g., a media container with a plant presentation media gel in the bottom. A liquid media layer is provided over the top of the gel media. Cut plants typically require a relatively large amount of water in the first hours after they are cut, so the described combination of features provides a dose of rapidly available liquid media for that phase of processing. Later, fluids are available to the cut plant from the gel, in a form that minimizes evaporation and spilling, e.g., in processing after initial sorting and packaging.

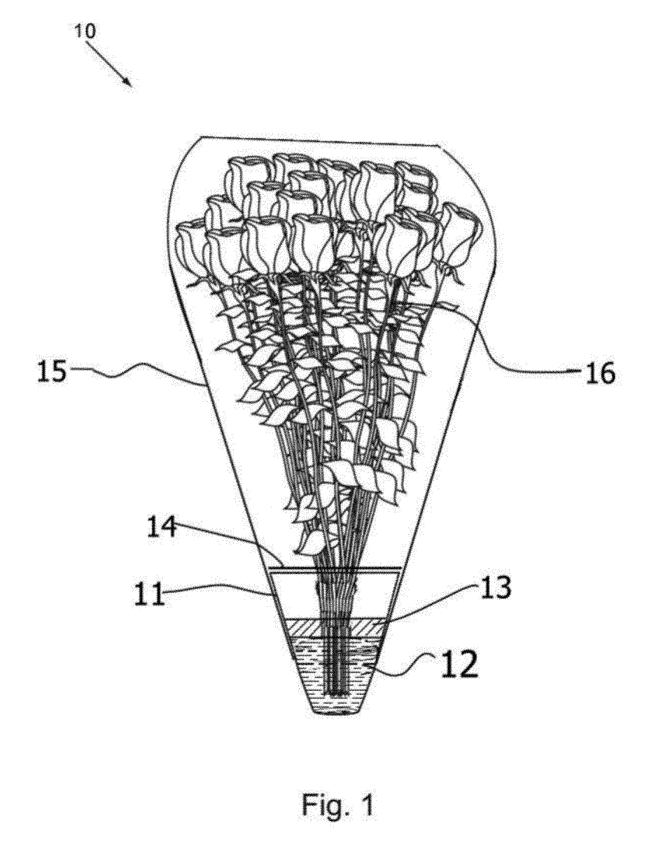

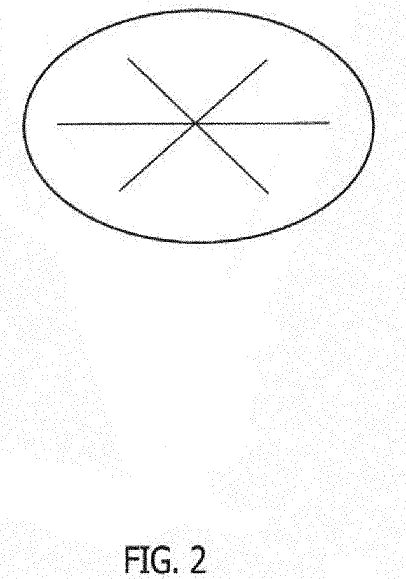

In many embodiments, the system includes additional features that enhance the ease of processing, reduce spillage, reduce evaporation, protect the plant from trauma, and/or help control the ambient humidity around, e.g., the plant/bloom and help prevent/control/dramatically reduce Botrytis/molds/fungal diseases. For example, the system can include a container cap having inward protrusions to grip inserted plants and provide separation of media from the environment (see, e.g., FIG. 2). The system can include a sleeve (e.g., perforated) projecting up from the container around the mid- and top regions of the plant for protection, transpiration control, and presentation. For example, as shown in FIG. 1, the system 10 can include container 11, gel media 12, liquid media 13, cap 14, sleeve 15, and cut plants 16.

The container is typically, e.g., a cup with adequate structure to hold the media, support the cut plant in a substantially vertical orientation, provide a base for a cap or sleeve, and/or to be effectively received and retained in a holding rack. In some embodiments, the container can be flexible or have a flexible bottom, so that the gel media can be mixed, or fragmented by application of external forces e.g. by squeezing. For example, the container can be a bottom section of the sleeve.

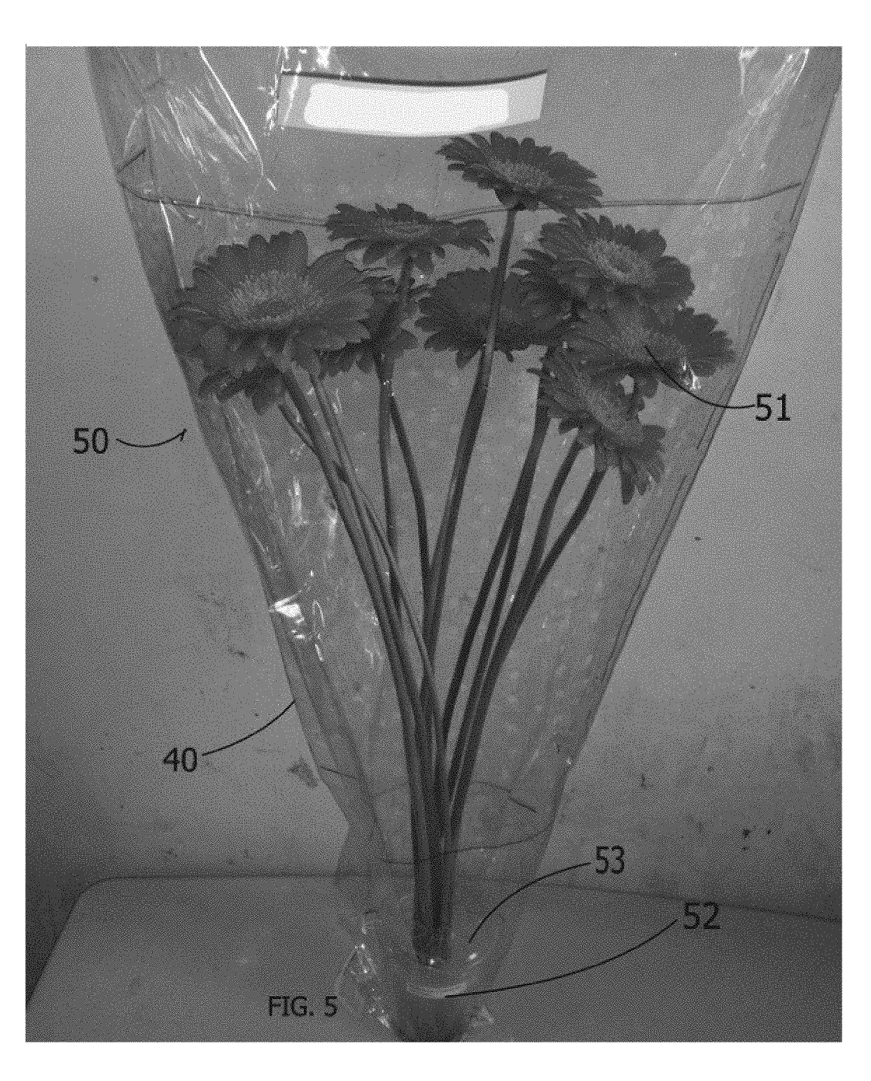

The container can have a cap to help seal in media and reduce evaporation. The cap can feature a surface readily penetrated by a cut plant and adapted to capture the plant. For example, the cap can be a resilient and/or pierceable membrane. Alternately, the cap can be a plastic cap with slits or weakened linear features that create inwardly projecting protrusions in the cap when the plant is thrust down through the cap, as shown in FIGS. 2 and 5. For example, the plant stems can be thrust down through the cap, bending the protrusions down creating a one-way biased grip of the cap on the stems. Such a cap can keep the stems centered in the cup, and prevent easy removal of the stems. In fact, the cap can be configured so that the entire system (plant and filled container) can be lifted as one by the stems. Alternatively, the cap can be a puncturable cling film or plastic wrap that can be heat-sealed on the cup.

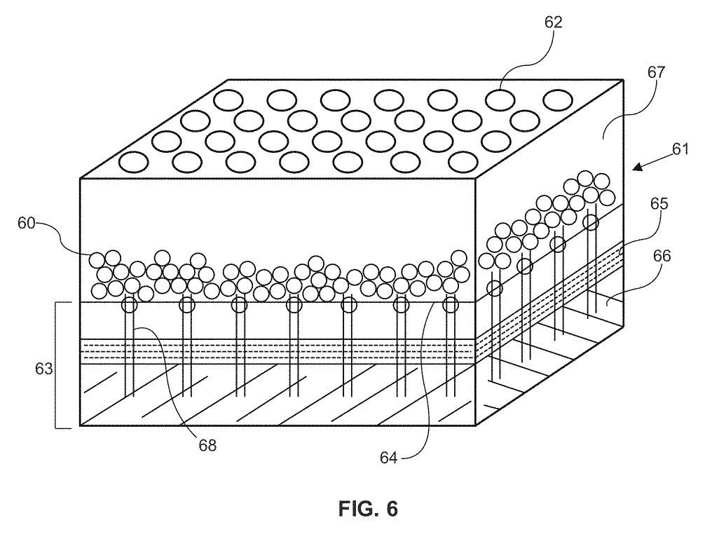

The container can be fabricated from any suitable material, but is typically made from a clear or translucent plastic. The container can be adapted to receive one or more flowers, e.g., 1 to 36 or more, 2 to 48, 5 to 20, or about 12 flowers. In certain embodiments, the container can be broad and capable of receiving an array of plants for preservation (see, e.g., FIG. 6). The container can hold an amount of gel/liquid media as required for the plant demand over the expected holding time. For example, the container can hold less than 10 ml to more than five liters, from 25 ml to 1 liter, from 50 ml to 250 ml, or about 150 ml. The container is typically taller than wide. The container can range from more than 50 cm height to less than 5 cm, from 25 cm to 10 cm, or about 15 cm. The container is typically tapered, being narrower at the bottom than top, e.g., facilitating placing and holding in racks.

The liquid media can be water, or a solution or suspension, e.g., featuring elements aiding in the preservation of cut plants. For example the liquid media can be pure water, with or without a sugar, salts, hormones, and/or antimicrobial compositions.

The liquid media of the invention, e.g., can provide inhibition of microbial growth while providing the plants with water and a favorable hormonal environment. The growth of microbes can be inhibited, e.g., by the substantial absence of oxygen and CO₂ in the system, by the absence of sugar in the preservative, and/or by the presence of anti-microbials in the preservative liquid. Water, salts, and hormones can help prevent abscission (dropping of leaves, fruit and petals) and wilting of the flowers. In one embodiment, the preservative liquid of the invention includes, e.g., an auxin (e.g., indole-3-butyric acid), a cytokinin (e.g., Zeatin), copper sulfate, citric acid and/or baking soda, salts, and vitamins

The gel is typically a hydrophilic polymer. The gel can function to physically stabilize the plant cut ends in the container, prevent spilling of liquid, provide slow release availability of water to the plants, and can form a “skin” reducing water loss and strengthening stem support. Compared to a liquid preservative, such gels can slow down absorption by a cut flower. As a result, transpiration is less and damaging humidity and condensation are reduced around the upper plant, e.g., leaves and bloom.

Preferred gels are polyacrylamide and agarose. The gel can include the gel polymer can be present in amounts of less than 0.5 g/L to more than 10 g/L, from 1 g/L to 5 g/L, from 1.5 g/L to 3 g/L, or about 2.5 g/L. The gel is typically a continuous gel, but can be in the form of fragments of beads. The gel can be hydrated with a liquid media. The liquid media can be the same as in the liquid media layer of the system, or the gel can be hydrated with a different liquid media.

The system can include a plastic sleeve located above the container, e.g., surrounding plant parts outside (e.g., above) the container. As many plants of interest, such as cut flowers, are generally wider at the top than the bottom, the plastic sleeve can have, e.g., a tapered or conical shape. The top of the plastic sleeve can have, e.g., a sealable opening, e.g., about 1 inch wide, or more, to receive a single small plant. The top of the plastic sleeve can have, e.g., a sealable opening about 4 inches wide, or more, to receive a bouquet of flowers or a bushy plant. In one example embodiment, for preservation of a dozen flowers, the plastic sleeve is a 36-inch long tapered shape with a 6-inch wide base and a 18-inch wide top, cut and sealed from 2 layers of 2 mil polyethylene film. In another embodiment, the plastic sleeve can be, e.g., a cylindrical sleeve of plastic film with a top end opening and a bottom end opening; in such a case, e.g., the bottom opening can be sealed to or around the container to form the environment control volume container of the invention, while the top end presents an opening to receive e.g., flowers.

The sleeve of the invention can, e.g., protect plants from physical damage. The sleeve can, e.g., form a protective boundary against intrusion of sharp or abrasive objects that can damage delicate plants. The pneumatic pressure of the gases within the container can, e.g., repel certain blunt or crushing forces the container might experience in transit and handling.

The structure of the sleeve can play an important role in controlling botrytis/molds/fungal and other diseases in the cut plants to be preserved. This sleeve typically highly perforated and adapted for (1) good aeration: which is source for cells to derive sufficient energy from mitochondrial combustion; (2) reducing humidity around bloom/leaves; (3) decreasing ethylene around bloom/stems/leaves; and (4) protecting the upper plant parts from physical injury.

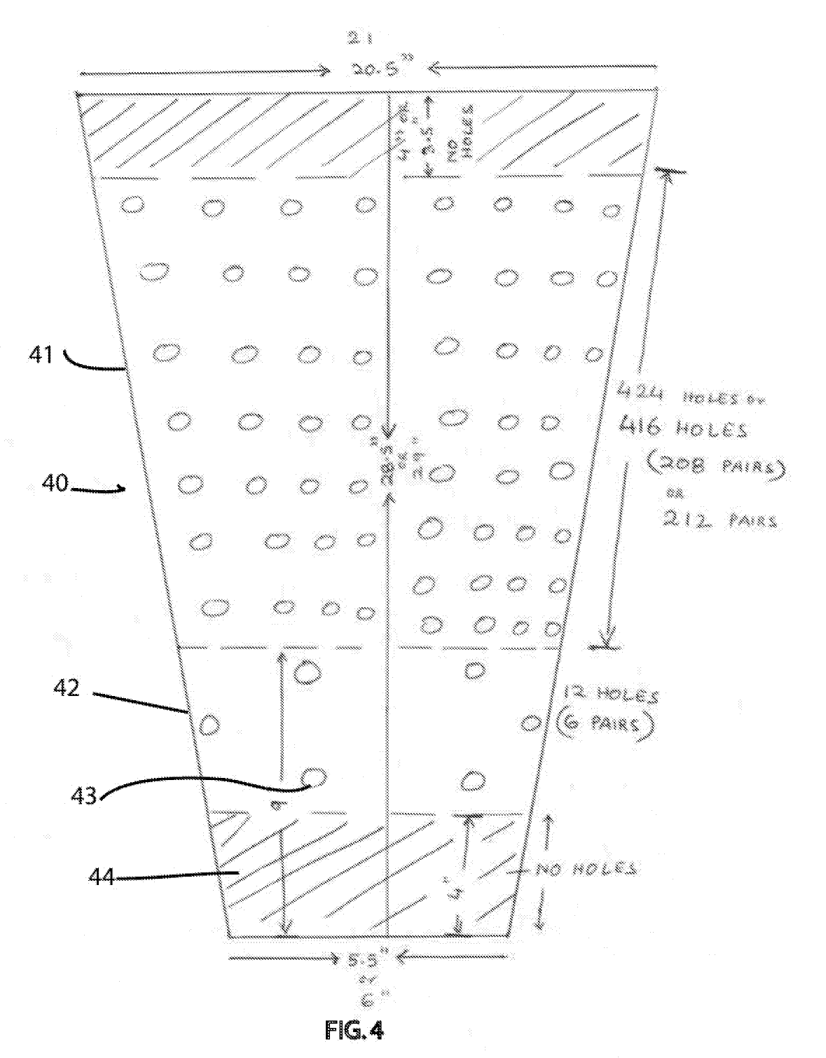

In one embodiment, the sleeve is designed to cooperate with the two phase liquid/gel hydration system discussed herein. The sleeves (e.g., as shown in FIG. 4) can provide adequate ventilation to upper plant parts, e.g., for the first 1-2 days after harvest when the rate of transpiration is relatively high, and being serviced by the liquid layer above the gel. After the liquid layer is absorbed and transpiration is reduced, the perforated sleeve continues to promote a humidity level high enough to reduce water usage while retaining healthy and attractive plant features, and reducing microbial growth. Conventional sleeves, without the combination of perforation features, can support growth of molds/botrytis/fungal diseases, and do not typically complement the system to provide the full cut plant shelf life possibilities. For example, prior art sleeves using 12 or less holes of 0.3-0.4 inch diameter or using microporous membrane sleeves do not typically provide the full benefits in the present system.

In many embodiments, the plastic sleeve is configured to provide a supportive environment for the plant parts above the container, or above the liquid/gel. The plastic sleeve can be made from flexible plastic sheet from less than 0.5 mil to more than 5 mil, from 1 mil to 4 mil, from 1.5 mil to 3 mil, or about 2 mil. The sleeve is preferably clear or translucent, but possibly opaque to meet the storage requirements of some plants.

The opening at the top of the sleeve can be flexible to aid in sealing the container. The top of the sleeve can be gathered, e.g., by folding or twisting, then bent back on itself and fixed in place with a tape, adhesive, band, or clip to form a substantially gas impermeable seal. Other sleeve constructions and seals can be readily appreciated by those skilled in the art. In preferred embodiments for the present systems, the top of the sleeve is left open.

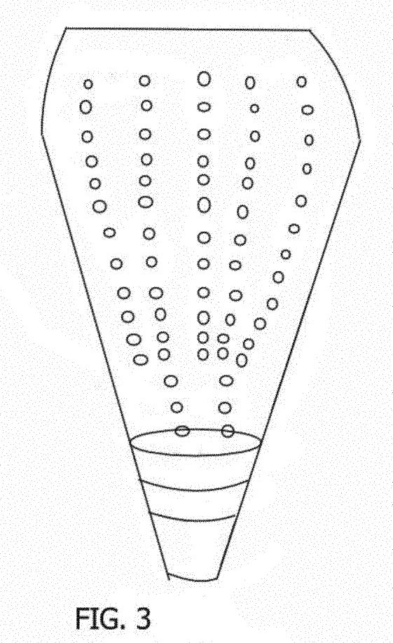

The sleeve can be, e.g., perforated to allow gas exchange with the external atmosphere in some situations. As shown in FIG. 3, for example, sleeve can have one or more gas exchange perforations. The perforations can number, e.g., from about 3 to about 100, or more, depending on the size of the container and the gas exchange requirements of the plants. The perforations can range in size, e.g., from about 0.1 mm to about 10 mm, 1 mm to 6 mm, or about 4 mm Perforations in the small size range can be, e.g., more numerous for adequate gas exchange, while small enough so that liquids, such as condensate or media, cannot drain through.

The perforations can be numerous in upper sections, e.g., in embodiments to protect cut flowers. For example, there are typically 100 to 600 perforations in the upper section. We also find is beneficial to also include a smaller number of perforations near the bottom of the sleeve to vent the wet upper surface of the liquid or gel in the container. For example, 2 to 16 or about 8 perforations may be in the first 2 to 6 inches about the container.

Plants that can benefit from the preservation systems can include flowers, fruits and vegetables, e.g., roses, gerberas, alstromeria, lilies, a mixed bouquet of flowers, raspberries, blueberries, cherries, plums, apricots, avocados, asparagus, tomatoes, beans, cucumbers, and/or the like. The present systems and methods are particularly suitable for any cut plant wherein the cut is at a stem. However, plants cut on other surfaces can benefit from the techniques outlined herein.

### Methods of Preserving Cut Plants

When flowers are cut, they can rapidly lose their attractive appearance. Almost immediately, water lost to transpiration from the leaves cannot be replaced, so the flower wilts. Later, even if the cut flower stems have been placed in water, hormonal and enzyme systems can degrade the flower so it becomes discolored and loses flower petals and leaves. The flowers can be physically traumatized by routine handling in commerce. Condensation on flowers and shipping materials can suffocate plant tissues and provide a breeding ground for undesirable microbes. Degradation of the flowers can be aggravated by accumulation of ethylene gas and bacterial or fungal infestations. On the other hand, degradation of cut flowers can be delayed by providing, e.g., a ready supply of water, conditions of humidity control, hormone balance, and nutrition.

The methods for preserving cut plants generally include the steps of providing the inventive system of the invention, e.g., including a container with a bottom gel media, covered with a liquid media layer. Cut surfaces of plants are, e.g., inserted through the liquid media and into the gel media. The plant portions above the media can be surrounded by a perforated plastic sleeve.

Gel media can be prepared by hydrating dry polymer with water or a desired liquid media. The polymer is suspended and the composition is typically heated to expedite hydration of the gel polymer and to sterilize the gel media. The melted gel is poured into the container bottom and allowed to cool or polymerize to a gel state. The desired liquid media is poured over the gel to provide the liquid media layer. The container and media are ready to receive one or more cut plants.

In preferred methods of the invention, an environment of relatively high humidity and an environment of relatively low humidity are established. Flowers are preserved by placing at least 50%, at least 60%, at least 75%, at least 90%, or at least 95% of the flower stems and/or leaves in the relatively high humidity environment. A relatively high humidity environment, e.g., for leaves of flowers can have a relative humidity at least 5%, at least 10%, at least 20%, at least 35%, or at least 50% higher than the relatively low relative humidity, e.g., for blossoms of the flower. For example, leaves can be in a relatively high humidity environment of 85% relative humidity as compared to a relatively low humidity of 75% relative humidity—the leaf environment having a relative humidity 10% higher than the blossoms.

### EXAMPLES

The following examples are offered to illustrate, but not to limit the claimed invention.

### Example 1

### Preserving Cut Flowers

Five-gallon buckets are cleaned and partially filled with a bleach solution. Immediately after harvest, flower stem ends are placed in the bleach solution. They are moved to a warehouse where plants are graded/bunched and placed back into the bleach solution.

A liquid media is prepared, including plant hormones, antimicrobials, and a balanced salt solution. A gel media is prepared by hydrating a polymer powder of agarose with the liquid media and heating. The still fluid gel media is poured into clean and sterile containers, filling about 60% of the volume. When the gel media is at least thick (e.g., viscous) or semisolid, liquid media is poured over the gel to form a liquid layer taking up about 20% of the container volume. The gel may continue to thicken, solidify, cross-link, or polymerize after pouring into the container. A container cap is placed over the top opening of the container.

The flowers are held in the bleach buckets, e.g., for a couple of hours before transferring them to the containers. The flowers are assembled into bouquets of about a dozen flowers, with the stems bundled with a rubber band. The bundled stems are thrust onto the container cap, breaking pre-etched lines defining angular protrusions that are bent down and press against the bundled stems. The stems progress down through the liquid media and into the gel media.

The flowers are lifted by the stems, and bring along the container and media which are held by the protrusions of the container cap. The flowers and container are inserted into plastic sleeves that rise up in an inverted cone, wider at the top. The cut flowers consume a relatively large amount of media the first hours after being cut. This quickly draws down the liquid media layer. If the flowers are held in storage a day before shipping, the liquid layer will be gone, while the flowers remain fully hydrated.

With the liquid layer diminished or gone, the packaged flowers can be shipped and handled with reduced chances the media can spill out of the container. Such spills can be unsightly and reduce the fresh shelf life of the flowers.

With the flowers on display in a retail setting, the flowers continue to draw liquid media from the gel. The gel shrinks and a structural gel membrane layer can form on top. The membrane further secures the flower stems and reduces evaporation of the gel. The membrane presents a poor surface for microbial growth. Such a system is maintenance-free. Flowers in their containers/sleeves can be displayed as packaged items.

The perforated sleeve protects the flowers and helps control the environment around the upper portions of the flowers. The perforations allow ethylene gas to diffuse away from the flowers, and allows high humidity around the flowers without excessive amounts of condensation.

Handling of the flowers has been easy and efficient. The flowers in the system can expect to have an extended attractive shelf life over old art techniques.

### Example 2

### Exemplary Sleeves

A sleeve has been designed to provide enhanced functionality of systems with the liquid/gel hydration scheme.

As shown in FIG. 4, The sleeve 40 is a cone wider at top and narrow at bottom, with the bottom end being sealed. For example a sleeve for gerberas (e.g., daisies) is 28-29 inches deep (long, top to bottom), 20-21 inches wide at upper edge and 5-6 inches wide at the lower end. In the upper area 41 of the sleeve, about 17 inches along the length of the sleeve (which is 8-9 inch from lower edge and 4 inch from upper edge) there are 424 holes each being quarter inch in diameter. This 17″ area is highly perforated with the ability to efficiently remove moisture released by the plant parts due to transpiration. In the middle area 42 of the sleeve, there is a lower density of perforations 43. Finally, there is a lower area 44 that receives the container and has no perforations. The level of humidity is dramatically lower, compared to old art sleeves. In our system, this provides a level of humidity (e.g., around the leaves, and less so at the blossom) to reduce water usage while reducing the incidence of diseases, e.g., botrytis, molds, fungal diseases.

Typical employment of an entire system with components interacting to provide extended attractive shelf life for daises is shown in FIG. 5. The preservation system 50 employs the sleeve 40, e.g., of FIG. 4. The daisies 51 are inserted into container 52 through cap 53 (having internal projections) before the flowers and container are placed inside the sleeve for transport and storage.

### Example 3

### Preserving Gerberas

Gerberas, such as daisies, benefit substantially from materials and methods described herein. Cut flowers can maintain freshness for more than 14 days with cut ends in the present preservation systems.

Step 1: Harvest the flowers by cutting stems.

Step 2: Immediately place flowers in Everfresh-Gel in a pouch or cup. The preservative container includes preservative gel layered over with a fluid comprising a preservative solution. The preservative solution is not necessary to provide 14 days of freshness, but can be provided with water over the gel. Water or preservative liquid can be provided once at day one or can be replenished at any of the steps from farm to end user.

Step 3: Flowers in gel as such go from a growers to distributors to retailers to end consumers with extended attractive life of flowers in homes of end-consumers.

Step 4: As and when needed, grower, distributor, retailer, or end consumer can add small volume of water or preservative solution over the Gel periodically to keep the Gel hydrated. Volume of fluid will vary depending upon the number of stems, temperature, and presence/absence of sleeves.

These procedures preserve Gerberas longer while eliminating many of the handling and materials costs for the floral industry. For example, the systems and procedures reduce requirements for, e.g., maintenance, equipment, processes, treatments, cutting/handling/change of water, buckets/proconas/containers and vase powder.

### Example 4

### Application of EverFresh to Fruits and Vegetables

Systems and methods of the invention can be used in formats compatible with stemmed fruits and vegetables, e.g., in a container having an expanded surface area. The layered liquid media and gel media are can be applied to a broad container to receive stems from an array of stemmed plants.

For example, as shown in FIG. 6, an array of plants 60, can be preserved as an array in a box 61 having vent holes 62. Plant stems 68 can be run through support sheet 64 and down through liquid media layer 65 to gel layer 66.

The box can be made of one time use organic or non-organic material. Box will be divided by a horizontal septum into two compartments—upper compartment 67 & lower compartment 63. Lower compartment has the gel and overlaid fluid. A perforated lid can be used to close the box.

The upper compartment can hold fruit, vegetables, and/or flowers, or a twig of medicinal plant. Stalks or roots of the fruit or vegetable, e.g., blue berries or grapes, will pass through perforation into the gel.

Protocol: Harvest fruit or vegetable having input vasculature, e.g., stems or roots. Insert vasculature (e.g., cut stalks of blue berries or a vegetable, e.g., asparagus or grapes) through perforation into the gel/overlaid fluid. Close the lid. Transport packaged product to retailer. Transport plants to end users in the carton package or, e.g., transfer bunched fruit or vegetable in smaller portable preservation systems described herein.

At the kitchen counter of end consumer, one can pluck the vegetables and cook on demand It is like plucking from mini kitchen garden. A retailer or end consumer can add small amount of water (depending upon the size of the box) to keep gel hydrated. This way flowers, fruits or veg will remain very fresh far longer than for prior art systems.

Sometimes products can have characteristic fresher than farm fresh, e.g., because the gel can be supplemented with one or a group of ingredients which may have ability to induce drinking and retention of water by the fruit/veg.

Ingredients in the gel can be organic and/or non-organic, properly tested and guaranteed for safety of the end consumers. Ingredients of the gel should be edible containing inorganic and organic compounds which are nutritious and beneficial for human health. The gel itself can be edible, e.g., with approved substances preventing growth of microbes.

Ingredients of the gel can be modified to make a fruit/veg more valuable in many ways. For example, healthy fruit can be made richer in a specific vitamin or a group of vitamins Taste/flavor can be created or/and enhanced. Fruit can be made crispier or softer. Labile vitamins or substance could become more stable retained inside such fruit/veg. The systems can provide a means to store valuable and labile plant materials without refrigeration.

The shelf life of such fruit/veg in our product can increase—approximately twice, e.g., if blue berries on kitchen shelves go for 6 days, then a shelf life of 10-12 days can be obtained using the present systems.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

1. A system for preserving cut plants, the system comprising:
a media container;
a gel media at a bottom of the container; and,
a liquid media layer above the gel media in the container.

2. The system of claim 1, wherein the media container further comprises a cap with one or more projections extending in axially at a top of the container.

3. The system of claim 1, wherein the media container comprises a flexible bottom half.

4. The system of claim 1, wherein the gel media comprises a hydrophilic gel selected from the group consisting of: a polyacrylamide and an agarose.

5.-8. (canceled)

9. The system of claim 1, further comprising a plastic sleeve projecting up from the media container, which sleeve comprises 8 or more perforations.

10. The system of claim 9,wherein the sleeve comprises from 4 to 16 perforations in a lower 20% of the sleeve above the container and 100 to 600 perforations in the upper 80% of the sleeve above the container.

11. (canceled)

12. The system of claim 9, wherein the sleeve plastic comprises a thickness ranging from 0.75 mil to 2 mil.

13. A cut plant in the system of claim 1, with a cut surface in contact with the gel.

14. The system of claim 13, wherein the plant is selected from the group consisting of a cut flower, a daisy, a rose, an Asteraceae, a Compositae, a fruit, and a vegetable.

15. (canceled)

16. A method of preserving a plant, the method comprising:
providing a media container comprising a closed bottom end, side walls and a top end;
placing a gel media in the bottom end of the container;
placing a liquid media in the container so that it rests in a layer above the gel media; and,
placing a cut surface of the plant into the gel media.

17. The method of claim 16, wherein the cut surface of the plant is held in a bleach solution for at least 2 hours before the cut surface is placed in the gel media.

18. The method of claim 16, wherein the cut plant is held in the container until the liquid media layer above the gel media is consumed.

19. The method of claim 18, further comprising transporting the cut plants in the container after the liquid media above the gel media is consumed.

20. The method of claim 16, wherein the gel media is a hydrated gel and the cut plant is held in the gel media until at least 50% of a gel hydrating liquid is consumed.

21. The method of claim 19, wherein the gel media is adapted to form a tough skin as the hydrating liquid is consumed.

22. The method of claim 16, wherein the media container top end comprises protrusions extending internally, and further comprising capturing the cut plant with the protrusions.

23. The method of claim 16, further comprising breaking a gel matrix of the gel media to release a liquid to the plant, or applying additional liquid media above the gel media after an initial liquid media has been consumed.

24. The method of claim 16, further comprising providing a plastic sleeve above the container and surrounding an upper portion of the cut plant.

25. A system for preserving cut plants, the system comprising:
a flexible media container; and,
a gel media at a bottom of the container;
wherein the gel is adapted to release liquid media when compressed or crushed by external forces through the flexible container.

26. The system of claim 25, wherein the gel is a polyacrylamide and an agarose.

27. (canceled)
